(19) United States
(12) Patent Application Publication
(10) Pub. No.: US 2022/0042682 A1
(43) Pub. Date: Feb. 10, 2022

(54) DIAGNOSIS SUPPORT DEVICE AND DIAGNOSTIC METHOD

(71) Applicant: Azbil Corporation, Tokyo (JP)

(72) Inventors: Kayo SUZUKI, Tokyo (JP); Yuichi KUMAZAWA, Tokyo (JP); Tomoya NAKATA, Tokyo (JP)

(73) Assignee: Azbil Corporation, Tokyo (JP)

(21) Appl. No.: 17/380,216

(22) Filed: Jul. 20, 2021

(30) Foreign Application Priority Data
Aug. 4, 2020 (JP) 2020-132303

(51) Int. Cl. F23N 5/24

(52) U.S. Cl. CPC F23N 5/242; G06F 3/14; F23N 2223/04

(57) ABSTRACT

To detect a malfunction of a combustion device caused by the presence or absence of the flames of burners, a flame monitor includes a monitoring circuit configured to obtain first time series data about the flames at the time of ignition of burners in a combustion device, a first storage device configured to store the first time series data obtained by the monitoring circuit, and an output circuit configured to obtain second time series data with which the first time series data stored in the first storage device is to be compared and display the first time series data and the second time series data in a comparable manner in a display device.

### CROSS REFERENCE TO RELATED APPLICATIONS

This patent application claims the benefit of foreign priority to Japanese Patent Application No. JP 2020-132303 filed on Aug. 4, 2020, the disclosure of which is hereby incorporated by reference in its entirety.

### BACKGROUND OF THE INVENTION

The present disclosure relates to a diagnosis support device and a diagnostic method, and more particularly to a diagnosis support device and a diagnostic method for a combustion device.

A combustion device is a device that burns fuel using a burner provided in a combustion furnace. The combustion device is provided with a combustion safety device for operating and driving the combustion device safely. The combustion safety device is provided with an interlock so as not to start the combustion device or to stop the operation when certain conditions are not met.

A combustion control device determines non-ignition, flame failure, and the like based on signals from a flame monitor and, when conditions are not met, stops the startup and performs the lockout of the combustion device. For example, the combustion control device always monitors the combustion state via the flame monitor that detects the flame of the combustion device using a flame detection unit. If any problem occurs in the combustion device and an abnormality such as non-ignition or flame failure of the burner occurs, the combustion control device receives a flame presence/absence signal from the flame monitor and immediately closes a safety shut-off valve to prevent fuel from flowing into the combustion furnace (for example, Patent Literature 1).

### CITATION LIST

### Patent Literature

[PTL 1] JP-A-2011-208921

[PTL 2] JP-A-2013-120140

### BRIEF SUMMARY OF THE INVENTION

Since the combustion device locked out and stopped by the combustion control device is kept in the stop state and cannot automatically return to the original state, it is necessary to eliminate the cause of the lockout and then manually restore the original state. However, restoration from non-ignition and flame failure often takes time because of the complicated situation of burner peripherals, thereby leading to the stoppage of operation depending on the equipment. Accordingly, it is desirable to prevent the occurrence of an abnormality through maintenance and identify the cause of an abnormality at an early stage to shorten the recovery time.

However, since the flame monitor monitors the presence or absence of a flame in the combustion device by the flame detection unit, the flame monitor does not have information for identifying the cause of an abnormality or diagnosing signs of the abnormality. Accordingly, it is difficult to detect in advance signs of an abnormality caused by the presence or absence of the flames of burners and to identify the causes of the abnormality.

Accordingly, an object of the present disclosure is to provide a diagnosis support device and a diagnostic method that support the diagnosis of the combustion device to detect a malfunction of the combustion device caused by the presence or absence of the flames of the burners.

To achieve the above object, a diagnosis support device (5) according to an embodiment of the present disclosure includes: a monitoring circuit (51) configured to obtain first time series data about a flame at time of ignition of a burner in a combustion device; a first storage device (52) configured to store the first time series data obtained by the monitoring circuit; and an output circuit (53) configured to obtain second time series data with which the first time series data stored in the first storage device is to be compared and display the first time series data and the second time series data in a comparable manner in a display device.

In an embodiment of the present disclosure, the monitoring circuit may be configured to obtain the first time series data for a predetermined time after a flame detection unit starts monitoring of the flame in the combustion device.

In addition, in an embodiment of the present disclosure, the first time series data and the second time series data may include data about an operation of the flame detection unit that detects presence or absence of the flame in the combustion device.

In addition, in an embodiment of the present disclosure, the second time series data may be time series data about the operation of the flame detection unit obtained for a predetermined time after the flame detection unit started monitoring of the flame in the combustion device when the flame detection unit started monitoring of the flame in the combustion device in the past.

In addition, in an embodiment of the present disclosure, the diagnosis support device may further include a second storage device that stores the second time series data, in which the output circuit may be configured to obtain the second time series data from the second storage device.

In addition, in an embodiment of the present disclosure, the second storage device may be configured to store a plurality of sets of the second time series data with which the first time series data stored in the first storage device is to be compared, and the output circuit may be configured to include a selection circuit that receives a selection operation for selecting one or more of the plurality of sets of the second time series data stored in the second storage device and to obtain the second time series data selected by the selection operation.

In addition, in an embodiment of the present disclosure, the output circuit may be configured to plot the first time series data and the second time series data together in the display device.

In addition, in an embodiment of the present disclosure, the diagnosis support device may further include a diagnostic circuit that diagnoses the combustion device by comparing the first time series data with the second time series data.

In addition, a diagnostic method according to the present disclosure includes the steps of: obtaining first time series data about a flame at time of ignition of a burner in a combustion device and storing the first time series data in a first storage device; obtaining second time series data with which the first time series data stored in the first storage device is to be compared; displaying the first time series data and the second time series data in a comparable manner in a display device; and diagnosing the combustion device by comparing the first time series data with the second time series data displayed in the display device.

According to the present disclosure, the diagnosis for detecting a malfunction of the combustion device caused by the presence or absence of the flames of the burners can be supported.

### BRIEF DESCRIPTION OF THE SEVERAL VIEWS OF THE DRAWING

FIG. 1 is a diagram illustrating an overview of a combustion system including a flame monitor according to an embodiment of the present disclosure.

FIG. 2 is a diagram illustrating a structural example of a flame detection unit.

FIG. 3A is a diagram illustrating the structure of the flame monitor having a flame logger function according to the embodiment.

FIG. 3B is a diagram illustrating an example of the hardware structure of the flame monitor according to the embodiment.

FIG. 4 is a flowchart illustrating the operation of a flame logger.

FIG. 5 is a flowchart illustrating the operation of the flame logger.

FIG. 6 is a diagram illustrating an example of display of the flame logger.

FIG. 7 is a diagram illustrating comparison with teaching data.

FIG. 8A is a diagram illustrating an example of display of the flame logger.

FIG. 8B is a diagram illustrating an example of display of the flame logger.

FIG. 9A is a diagram illustrating a modification of a combustion system including the flame monitor according to the embodiment.

FIG. 9B is a diagram illustrating a modification of the combustion system including the flame monitor according to the embodiment.

FIG. 10 is a diagram illustrating a modification of the combustion system including the flame monitor according to the embodiment.

FIG. 11 is a diagram illustrating a modification of the combustion system including the flame monitor according to the embodiment.

### DETAILED DESCRIPTION OF THE INVENTION

An embodiment of the present disclosure will be described below with reference to the drawings.

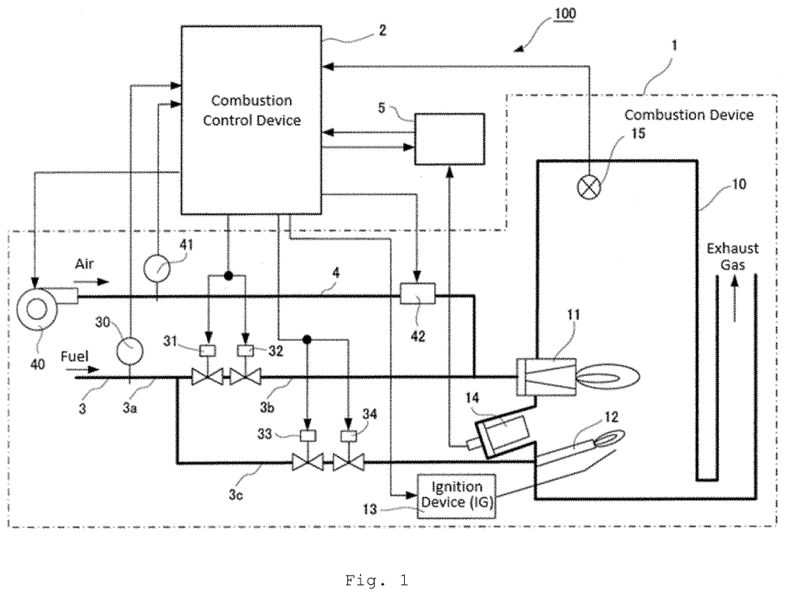

FIG. 1 illustrates an overview of a combustion system 100 having a flame monitor 5 according to the embodiment. The combustion system 100 includes a combustion device 1, a combustion control device 2, and the flame monitor 5.

Of these, the combustion device 1 includes a combustion furnace 10, a main burner 11 that heats the inside of the combustion furnace 10, a pilot burner 12 that ignites the main burner 11, an ignition device (IG) 13 that ignites the pilot burner 12, a flame detection unit 14 that detects the flames of the main burner 11 and the pilot burner 12, a fuel flow path 3 and an air flow path 4 that supply fuel and air to the burners, respectively, and a temperature sensor 15 that detects the temperature in the combustion furnace 10.

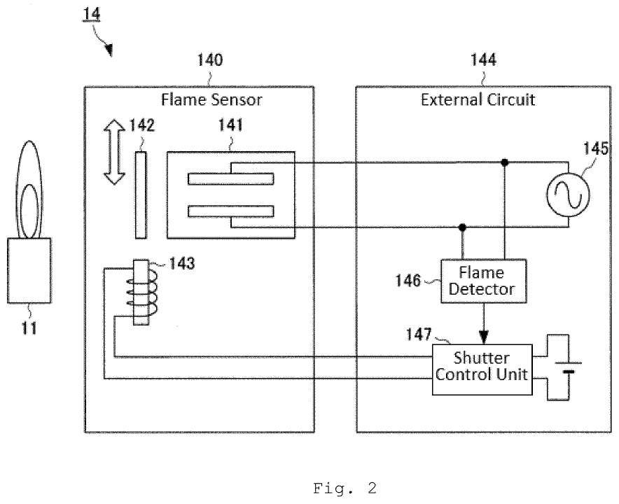

As illustrated, for example, in FIG. 2, the flame detection unit 14 includes a flame sensor 140 having an ultraviolet detection discharge tube (referred to below as a “UV tube”) 141 for detecting an ultraviolet ray emitted from a flame, and an external circuit 144 that includes an AC power supply 145 that applies a voltage between the discharge electrodes of the UV tube 141 and a flame detector 146 that detects the presence or absence of a flame of the burner 11 based on the discharge current flowing from the UV tube 141. The flame detection unit 14 illustrated in FIG. 2 further includes a shutter 142 movably provided on the front surface of the light receiving unit of the UV tube 141, a solenoid coil 143 that moves this shutter 142, and a shutter control unit 147 that supplies a current to the solenoid coil 143 (see, for example, Patent Literature 2). Instead of the UV tube, which is an ultraviolet flame sensor, another type of optical flame sensor such as a visible light flame sensor or an infrared flame sensor, or a flame rod that utilizes a flame conductivity phenomenon, may be used as the flame sensor 140.

The combustion device 1 includes a type that extinguishes the flame of the pilot burner 12 after the main burner 11 is ignited and a type that keeps the flame of the pilot burner 12 even after the main burner 11 is ignited. The flame detection unit 14 of the former type first detects the flame intensity of the pilot burner 12 and then detects the flame intensity of the main burner 11. The latter type detects the flame intensity of the pilot burner 12 and the flame intensity of the main burner 11 in combination. In addition, some types of the combustion device 1 have only the main burner 11 without the pilot burner 12. In the present disclosure, the main burner 11 and the pilot burner 12 may be collectively referred to as the “burners 11 and 12”. In addition, the flame detection unit 14 detects the flames of both the pilot burner 12 and the main burner 11 as the flames of the burners.

The fuel flow path 3 includes a main flow path 3a to which fuel is supplied from the outside, and a first flow path 3b and a second flow path 3c that are branched from the main flow path 3a. The first flow path 3b is connected to the main burner 11 and the second flow path 3c is connected to the pilot burner 12. A gas pressure switch 30 is provided in the main flow path 3a, safety shut-off valves 31 and 32 are provided in the first flow path 3b, and safety shut-off valves 33 and 34 are provided in the second flow path 3c.

The air flow path 4 supplies air to the combustion device 1, and has one end connected to a blower 40 and the other end connected to the first flow path 3b. The air discharged from the blower 40 is supplied to the main burner 11 via the first flow path 3b together with the fuel (gas). In addition, the air flow path 4 is provided with a wind pressure switch (airflow switch) 41 and a damper 42.

In contrast, the combustion control device 2 plays a role as a combustion safety device and performs various interlocks from the startup of the combustion device 1 to normal combustion according to the combustion sequence including, for example, “start check”, “pre-purge”, “ignition standby”, “ignition trial”, “pilot trial”, “main trial”, “normal combustion”, and the like. In addition, the combustion control device 2 monitors the states of the gas pressure switch 30, the wind pressure switch 41, the flame detection unit 14, and the like and, when detecting an abnormality, performs a lockout interlock that closes the safety shut-off valves 31 to 34 and shuts off the fuel supply to the burners.

In addition, the combustion control device 2 controls the operation of the combustion device 1 to adjust the temperature in the combustion furnace 10 to a certain target value (set value) by receiving a temperature detection signal from the temperature sensor 15 and outputting control signals to the safety shut-off valves 31 to 34, the ignition device 13, the blower 40, the damper 42, and the like.

The combustion control device 2 as described above may include various control relays, a computer including a processor and a storage device such as a distributed control system (DCS) or a programmable logic controller (PLC), and programs that achieve various functions in cooperation with these hardware components.

In addition to the monitoring of the presence or absence of the flames of the main burner 11 and the pilot burner 12 of the combustion device 1 using the flame detection unit 14, the flame monitor 5 according to the embodiment has a flame logger function that records the flame state at the start of combustion in the combustion device 1 so as to display the latest record and past record in a comparable manner when an abnormality occurs or maintenance is performed. This flame monitor 5 is used as a diagnosis support device that supports the diagnosis of a malfunction of the combustion device 1 caused by the presence or absence of the flames of the burners 11 and 12 of the combustion device 1.

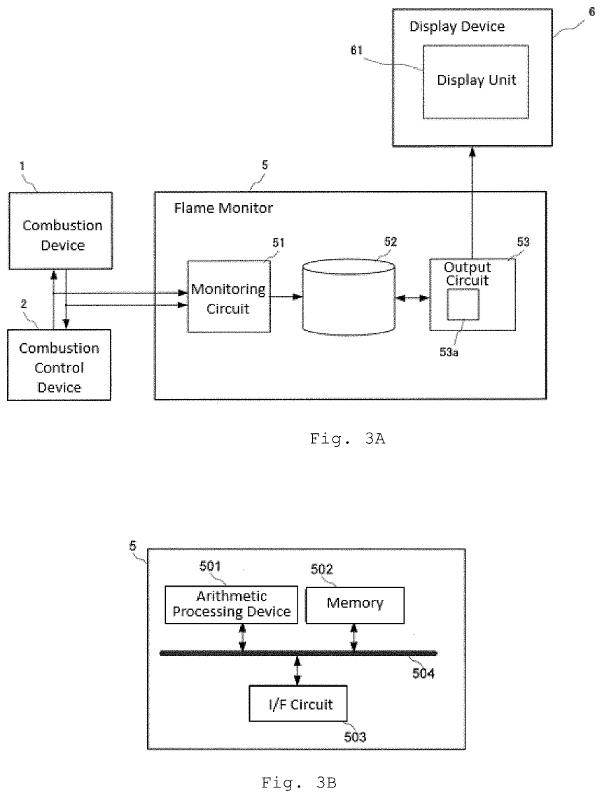

As illustrated in FIG. 3A, the flame monitor 5 includes a monitoring circuit 51 configured to obtain first time series data about the flames at the time of ignition of the burners 11 and 12 in the combustion device 1, a storage device 52 configured to store the first time series data obtained by the monitoring circuit 51, and an output circuit 53 configured to obtain second time series data with which the first time series data is to be compared from the storage device 52 and display the first time series data and the second time series data in a comparable manner in a display unit 61 of a display device 6.

Here, both the first time series data and the second time series data are obtained by collecting, at predetermined intervals, the time series signals of various sensors and control signals about combustion control, that is, various signals obtained from the flame detection unit 14 and various control signals output from the combustion control device 2.

In the embodiment, the various signals obtained from the flame detection unit 14 are information about the operation of the flame detection unit 14 and include, for example, a flame detection signal (flame presence/absence signal) output from the flame detection unit 14, a self-check flame detection unit shutter signal representing the operation of the shutter 142 of the flame detection unit 14, a flame level when the shutter 142 is open, that is, the self-check flame detection unit state signal, a flame voltage (flame voltage value), and the like. In addition, various types of control information output from the combustion control device 2 may include a startup input (startup signal of the flame monitor), startup relay ON (flame monitor startup relay signal), flame relay ON (flame monitor flame monitoring relay signal), and the like. Furthermore, the operating state number (flame monitor operating state number) indicating the operating state of the flame monitor 5 may be obtained and stored in the storage device 52. The signals, control information, and the like described above may be collectively referred to as “maintenance information”.

The monitoring circuit 51 is configured to obtain time series data for a predetermined time after starting the monitoring of flames in the combustion device 1 by the flame detection unit 14. Specifically, the monitoring circuit 51 obtains the maintenance information described above for, for example, 10 seconds at 0.1 second intervals after starting the monitoring of the flame of the burners 11 and 12, and stores this information as time series data associated with time information in the storage device 52.

More specifically, the monitoring circuit 51 has a timer (not illustrated) and obtains the maintenance information at 0.1 second intervals for 10 seconds after occurrence of a trigger, which is a transition of the flame monitor 5 from a stop state to a flame monitoring state (flame presence/absence monitoring state), associates the maintenance information with time information, and stores the associated maintenance information in the storage device 52.

It should be noted that the period (10 seconds) and the interval (0.1 seconds) for monitoring the maintenance information described above are examples, and these values may be arbitrarily set within the range in which information about the flames at the time of ignition can be reproducibly obtained.

In addition, the trigger may be set to the ON/OFF of the contacts from external devices such as a PLC and a DCS constituting the combustion control device 2 instead of the state transition of the flame monitor 5.

The time series data to be diagnosed in the diagnostic process described later, such as the time series data that is obtained by collecting the maintenance information in real time or the latest time series data obtained, may be referred to as the “first time series data”. On the other hand, the time series data, used for comparison with the first time series data described above, that has been obtained from the maintenance information when the combustion system 100 has been operated before, such as, for example, when the combustion system 100 has been operated for the first time or when the combustion system 100 has been operated immediately after the previous maintenance may be referred to as the “second time series data”. In addition, since the second time series data is used to diagnose a problem with the combustion device 1 by comparison with the first time series data as described later, the second time series data to be compared with the first time series data may be referred to as “teaching data”. In the embodiment, the first time series data and the second time series data include data about the operation of the flame detection unit 14 that detects the presence or absence of flames in the combustion device 1.

The storage device 52 is, for example, a storage device such as an HDD or an SSD, and is configured to store the maintenance information obtained by the monitoring circuit 51 in association with time information. In the embodiment, it is assumed that the storage device 52 stores a plurality of sets of time series data that are candidates for teaching data. The time series data that can be teaching data is, for example, the maintenance information obtained from the maintenance information when the combustion system 100 has been started for the first time, the time series data obtained from the maintenance information when the combustion system 100 has been operated before, such as when the combustion system 100 has been started immediately after the previous maintenance, or the time series data obtained from the maintenance information when the combustion system 100 has been started immediately after maintenance.

Although the storage device 52 is provided in the flame monitor 5 in the embodiment, a cloud server device on a network may be used as a storage device in which the time series data is stored.

The output circuit 53 is configured to obtain the first time series data and the second time series data stored in the storage device 52 and display the first time series data and the second time series data in a comparable manner in the display unit 61 of the display device 6. In addition, in the embodiment, a selection circuit 53a that receives a selection operation for selecting one or more of a plurality of sets of time series data stored in the storage device 52 is provided, so that it is possible to obtain any of the plurality of sets of time series data stored in the storage device 52 based on the selection operation received through a not-illustrated input/output device and display the obtained time series data in the display unit 61 of the display device 6.

Although the output circuit 53 obtains both the first time series data and the teaching data from the storage device 52 in the embodiment, the first time series data and the second time series data that is a candidate for teaching data may be stored in a plurality of storage devices that are different from each other. When the first time series data and the second time series data are stored in the plurality of storage devices that are different from each other, the output circuit 53 obtains a first time series data and a second time series data (teaching data) from the first storage device and the second storage device, respectively.

As illustrated in FIG. 3B, the flame monitor 5 described above may include a computer including an arithmetic processing device 501, a memory 502, an interface (I/F) circuit 503, and a bus 504 that connects these components in a communicable manner and programs installed in this computer. In this case, the monitoring circuit 51 and the output circuit 53 described above are achieved by the arithmetic processing device 501 controlled by programs and the interface circuit 503, and the memory 502 operates as the storage device 52 described above.

Next, the operation of the flame monitor 5 according to the embodiment will be described.

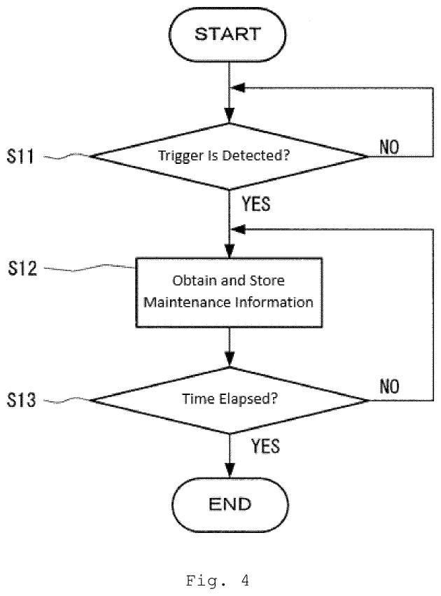

First, in the phase for obtaining time series data, as illustrated in FIG. 4, the flame monitor 5 monitors the control signal output from the combustion control device 2 and waits for detection, as a trigger, of a transition from the stop state to the flame monitoring state (flame presence/absence monitoring state) of the flame monitor 5 (NO in S11). After detecting the trigger (YES in S11), the flame monitor 5 obtains the maintenance information at predetermined time intervals (for example, 0.1 second intervals) and stores the maintenance information in the storage device 52 (S12), continues this until a predetermined time (for example, 10 seconds) elapses (NO in S13), and ends the obtaining of time series data when the predetermined time has elapsed (YES in S13).

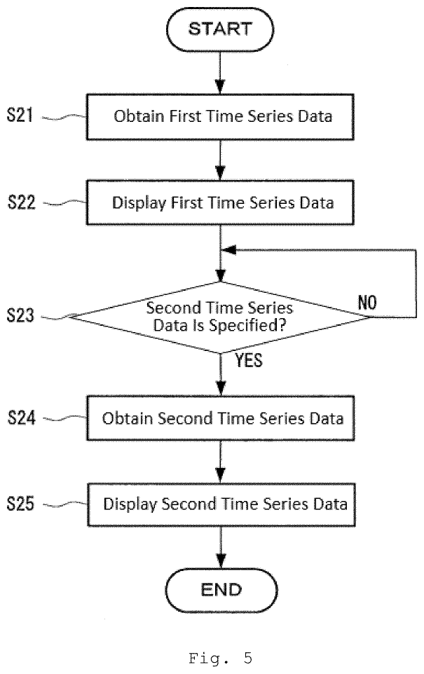

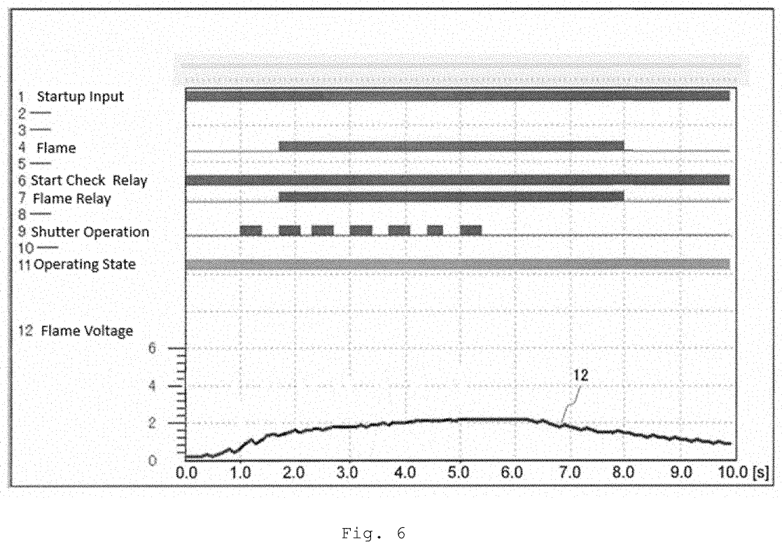

In the phase for displaying time series data, as illustrated in FIG. 5, first, the flame monitor 5 reads, as the first time series data, for example, the latest time series data from the storage device 52 (S21) and displays the read time series data in the display unit 61 of the display device 6 (S22). FIG. 6 illustrates a display example of the first time series data. In this example, “Startup Input (1)”, “(Presence or Absence of) Flame (4)”, “Start Check Relay (6)”, “Flame Relay (7)”, “Shutter Operation (9)”, “Operating State (11)” of the flame monitor, and “Flame Voltage (12)” are plotted for 10 seconds.

The flame monitor 5 obtains the second time series data to be compared with the first time series data from the storage device 52 (S24), and plots the obtained second time series data together with the first time series data in the display unit 61 of the display device 6 (S25). Since the plurality of sets of second time series data having been obtained before are stored in the storage device 52, before the second time series data is obtained (S24), the second time series data to be compared with the first time series data is selected from the plurality of sets of time series data (S23) in the embodiment. In this case, the flame monitor 5 waits for the user to input an operation for specifying the second time series data among the plurality of sets of time series data via an input/output device (not illustrated) (NO in S23) and, when an operation for specifying the second time series data is entered (YES in S23), proceeds to the step (S24) of obtaining the specified second time series data from the storage device 52.

At this time, by comparing the data (first time series data) obtained from the combustion system 100 during the combustion process with the teaching data (second time series data) such as the initial data when the combustion system 100 has been installed, the flame monitor 5 displays, on the monitor, a group of data for clarifying the behavior of the combustion device 1 at the time of ignition and determining an abnormality.

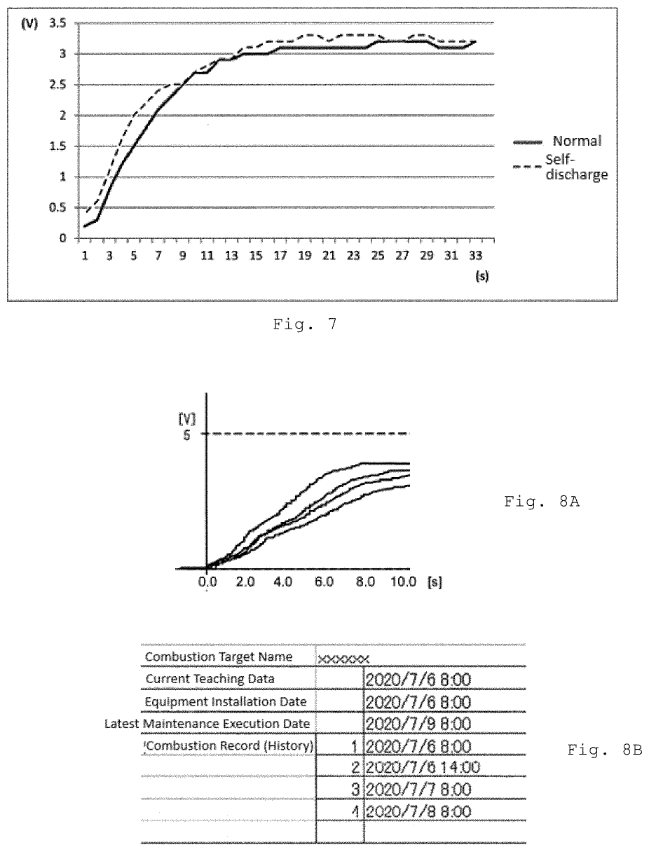

FIG. 7 illustrates temporal changes in the flame voltage output from the flame detection unit 14 when the burner is ignited as an example of the display of the flame monitor, in which changes when the flame sensor 140 is operating normally are indicated by a solid line and changes when the flame sensor 140 is self-discharging are indicated by a dotted line. As seen from FIG. 7, when the flame sensor 140 is self-discharging, the flame voltage tends to be higher than in normal time. Accordingly, by setting temporal changes in the flame voltage when the flame sensor 140 is operating normally to teaching data (second time series data) and comparing the first time series data with this teaching data, occurrence of a problem with the flame sensor 140 can be determined.

The flame monitor 5 according to the embodiment plots the first time series data and the teaching data (second time series data) together with respect to the common time axis in the display unit 61 of the display device 6. Accordingly, the user can diagnose the cause and sign of occurrence of an abnormality in the combustion device 1 by comparison between the first time series data and the second time series data displayed in the display device 6.

Specifically, the following diagnoses can be considered as a result of comparison between the first time series data and the teaching data (second time series data).

[Example 1] When the flame voltage is becoming lower than or is lower than the teaching data, it can be diagnosed that there is a sign of an abnormality in the flame detection unit.
[Example 2] When the shutter cycle is becoming disturbed as compared with the teaching data, there is a sign of an abnormality in the flame detection unit.
[Example 3] When a rise in the flame voltage is becoming faster or is faster than in the teaching data and the flame level (shutter open) signal is becoming disturbed, it can be diagnosed that there is a sign of self-discharge of the flame detection unit.

In the cases of examples 1 to 3, occurrence of non-ignition and flame failure can be prevented by replacing the flame detection unit during maintenance at an early stage.

[Example 4] When the flame voltage does not rise, it is suspected that the air ratio is deviating (the flame output does not increase because there is much air) or the ignition becomes difficult (ignition delay has occurred) because the spark rod is dirty.
[Example 5] When an ignition spark is detected by the flame sensor, it is suspected that the ignition has degraded or the position of the spark plug has deviated.

As described above, in the flame monitor 5 according to the embodiment, since the time series data (first time series data) about the maintenance information obtained at a predetermined time including the ignition stages of the burners 11 and 12 in the combustion system 100 and the teaching data (second time series data) such as the initial data when the combustion system 100 is installed are displayed in a comparable manner in the display device 6, the user can find a sign of a problem with the combustion device 1 and, even if the combustion device 1 is locked out and stopped, can identify the cause of the problem more easily.

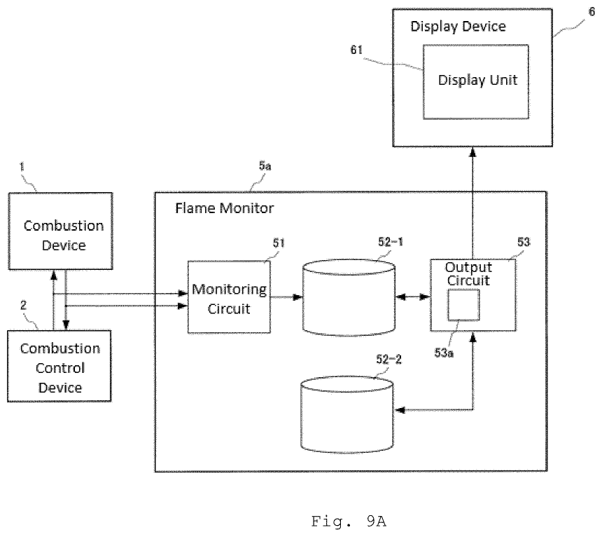

When the data is displayed in the display device 6, for example, a plurality of sets of time series data about the flame voltage may be displayed at the same time as illustrated in FIG. 8A. At this time, the attributes of the plotted time series data, that is, the information about the target combustion device, and the date and time at which the displayed teaching data and other time series data have been obtained, may be displayed. For example, in the example illustrated in FIG. 8B, “Combustion Target Name” and “Equipment Installation Date”, which are information about the target combustion device, as well as “Current Teaching Data” and “Combustion Record (History)”, which represent the date and time at which the teaching data and other time series data have been obtained, are displayed in a tabular format. Such information representing the attributes of time series data may be displayed in the display unit 61 of the display device 6 together with the plotted data as illustrated in FIG. 8A or may be displayed separately from the plotted data.

The information representing the attributes of the time series data is stored in the storage device 52 in association with the time series data.

### Modifications

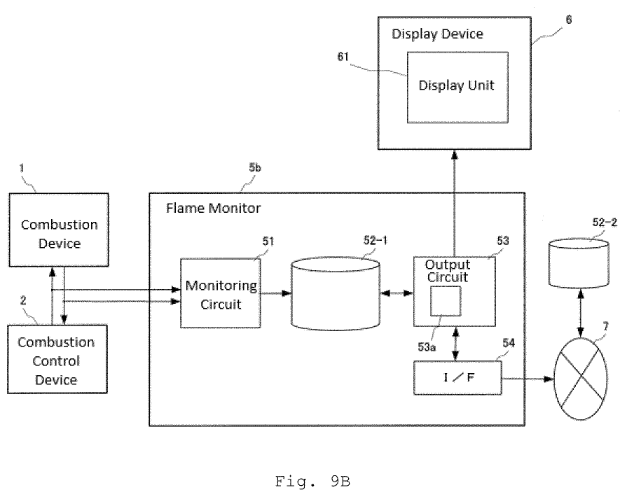

Both the first time series data and the second time series data are stored in the storage device 52 in the flame monitor 5 according to the embodiment described above, but, as illustrated in FIG. 9A, a plurality of storage devices that are different from each other, that is, a first storage device 52-1 and a second storage device 52-2 may be provided so that the first time series data and the second time series data are stored in the first storage device 52-1 and the second storage device 52-2, respectively.

In this case, both the first storage device 52-1 and the second storage device 52-2 may be provided in a flame monitor 5a as illustrated in FIG. 9A, but a network interface (I/F) circuit 54 may be provided in a flame monitor 5b as illustrated in FIG. 9B so as to connect to the second storage device provided outside via a network 7. By providing the second storage device outside the flame monitor 5b, the second time series data to be used as the teaching data can be centrally managed by, for example, a data center.

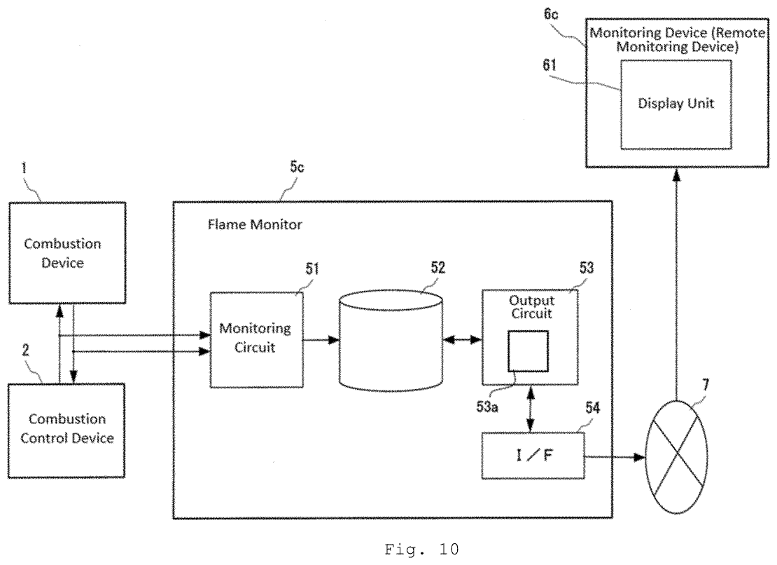

In addition, as illustrated in FIG. 10, a flame monitor 5c may be connected to the network 7 via the network interface circuit 54 so that the output circuit 53 displays the time series data in the display unit of a remote monitoring device 6c via this network 7.

In addition, a display example of information that indicates the attribute of time series data is illustrated in FIG. 8B, but the user may select the second time series data to be used as the teaching data based on information that indicates the attribute of time series data displayed in the display unit 61. When the user performs a selection operation via an input/output device (not illustrated), the selection circuit 53a obtains the selected time series data from a plurality of sets of second time series data (candidates for the teaching data) stored in the storage device 52 and the output circuit 53 displays the obtained time series data in the display device 6.

This allows the user to select the appropriate time series data from a plurality of sets of candidates for the teaching data according to the experience. For example, when the user is inexperienced, the user selects the time series data obtained on the installation date (“Equipment Installation Date”) of this equipment or the latest execution date (“Latest Maintenance Execution Date”) of maintenance as the teaching data. When the user is experienced, the user can select any time series data as the teaching data with reference to the “Maintenance Execution Date” and “Combustion Record”. Accordingly, it is possible to make a diagnosis based on experience.

In addition, as the information representing the attributes of time series data to be stored in the storage device 52 in association with time series data, the information that identifies the arc processed by the combustion device 1 may be added in addition to the information about the combustion device 1 and the information about the date and time at which the displayed teaching data and other time series data have been obtained that have been described above. In this case, the time series data associated with a specific type of arc may be extracted from the plurality of sets of time series data stored in the storage device 52 and the extracted time series data may be presented to the user as a candidate for the teaching data.

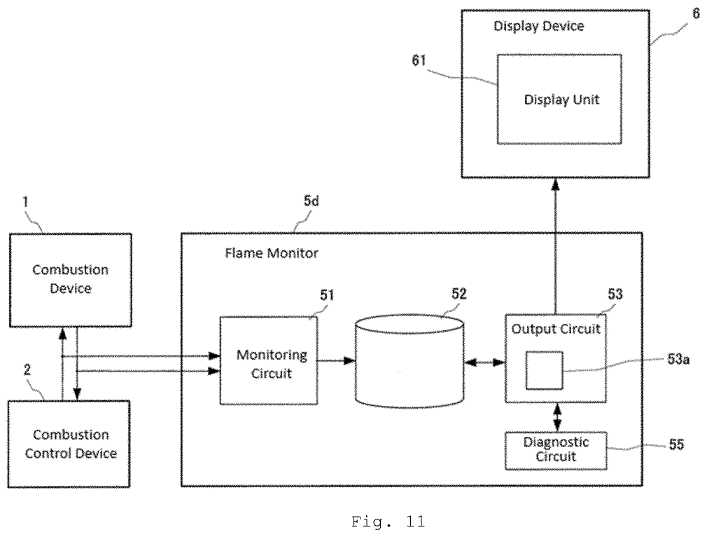

In addition, as illustrated in FIG. 11, a flame monitor 5d may be provided with a diagnostic circuit 55 that automatically diagnoses the combustion device 1 to be monitored by comparing the first time series data obtained by the monitoring circuit 51 with the teaching data selected by the selection circuit 53a.

For example, the diagnostic circuit 55 described above may compare two sets of time series data on a common time axis, calculate the magnitude of the alienation between the two and the correlation between the two, and detect the sign of occurrence of an abnormality and the location of a problem in the combustion device 1 based on these values. In addition, the results of the diagnosis may be displayed in the display unit 61 of the display device 6 via the output circuit 53.

### Extension of the Embodiments

Embodiments of the present disclosure and modifications thereof have been described above, but the present disclosure is not limited to the above embodiments, and various changes understood by those skilled in the art can be made within the scope of the present disclosure. In addition, the embodiments can be combined arbitrarily as long as no contradictions arise.

The present disclosure can be used to diagnose combustion devices.

### DESCRIPTION OF REFERENCE NUMERALS AND SIGNS

100: combustion system, 1: combustion device, 11: main burner, 12: pilot burner, 14: flame detection unit, 140: flame sensor, 141: UV tube, 2: combustion control device, 5: flame monitor, 51: monitoring circuit, 52: storage device, 53: output circuit, 53a: selection circuit, 54: network interface circuit, 55: diagnostic circuit, 6: display device, 61: display unit

1. A diagnosis support device comprising:
a monitoring circuit configured to obtain first time series data about a flame at time of ignition of a burner in a combustion device;
a first storage device configured to store the first time series data obtained by the monitoring circuit; and
an output circuit configured to obtain second time series data with which the first time series data stored in the first storage device is to be compared and display the first time series data and the second time series data in a comparable manner in a display device.

2. The diagnosis support device according to claim 1,
wherein the monitoring circuit is configured to obtain the first time series data for a predetermined time after a flame detection unit starts monitoring of the flame in the combustion device.

3. The diagnosis support device according to claim 1,
wherein the first time series data and the second time series data include data about an operation of a flame detection unit that detects presence or absence of the flame in the combustion device.

4. The diagnosis support device according to claim 2,
wherein the first time series data and the second time series data include data about an operation of the flame detection unit that detects presence or absence of the flame in the combustion device.

5. The diagnosis support device according to claim 2,
wherein the second time series data is time series data about the operation of the flame detection unit obtained for a predetermined time after the flame detection unit started monitoring of the flame in the combustion device when the flame detection unit started monitoring of the flame in the combustion device in the past.

6. The diagnosis support device according to claim 4,
wherein the second time series data is time series data about the operation of the flame detection unit obtained for a predetermined time after the flame detection unit started monitoring of the flame in the combustion device when the flame detection unit started monitoring of the flame in the combustion device in the past.

7. The diagnosis support device according to claim 1, further comprising:
a second storage device that stores the second time series data;
wherein the output circuit is configured to obtain the second time series data from the second storage device.

8. The diagnosis support device according to claim 5, further comprising:
a second storage device that stores the second time series data;
wherein the output circuit is configured to obtain the second time series data from the second storage device.

9. The diagnosis support device according to claim 6, further comprising:
a second storage device that stores the second time series data;
wherein the output circuit is configured to obtain the second time series data from the second storage device.

10. The diagnosis support device according to claim 7, wherein
the second storage device is configured to store a plurality of sets of the second time series data with which the first time series data stored in the first storage device is to be compared, and
the output circuit includes a selection circuit that receives a selection operation for selecting one or more of the plurality of sets of the second time series data stored in the second storage device and is configured to obtain the second time series data selected by the selection operation.

11. The diagnosis support device according to claim 8, wherein
the second storage device is configured to store a plurality of sets of the second time series data with which the first time series data stored in the first storage device is to be compared, and
the output circuit includes a selection circuit that receives a selection operation for selecting one or more of the plurality of sets of the second time series data stored in the second storage device and is configured to obtain the second time series data selected by the selection operation.

12. The diagnosis support device according to claim 9, wherein
the second storage device is configured to store a plurality of sets of the second time series data with which the first time series data stored in the first storage device is to be compared, and
the output circuit includes a selection circuit that receives a selection operation for selecting one or more of the plurality of sets of the second time series data stored in the second storage device and is configured to obtain the second time series data selected by the selection operation.

13. The diagnosis support device according to claim 1,
wherein the output circuit is configured to plot the first time series data and the second time series data together in the display device.

14. The diagnosis support device according to claim 10,
wherein the output circuit is configured to plot the first time series data and the second time series data together in the display device.

15. The diagnosis support device according to claim 11,
wherein the output circuit is configured to plot the first time series data and the second time series data together in the display device.

16. The diagnosis support device according to claim 12,
wherein the output circuit is configured to plot the first time series data and the second time series data together in the display device.

17. The diagnosis support device according to claim 1, further comprising:
a diagnostic circuit that diagnoses the combustion device by comparing the first time series data with the second time series data.

18. The diagnosis support device according to claim 13, further comprising:
a diagnostic circuit that diagnoses the combustion device by comparing the first time series data with the second time series data.

19. The diagnosis support device according to claim 16, further comprising:
a diagnostic circuit that diagnoses the combustion device by comparing the first time series data with the second time series data.

20. A diagnostic method comprising the steps of:
obtaining first time series data about a flame at time of ignition of a burner in a combustion device and storing the first time series data in a first storage device;
obtaining second time series data with which the first time series data stored in the first storage device is to be compared;
displaying the first time series data and the second time series data in a comparable manner in a display device; and
diagnosing the combustion device by comparing the first time series data with the second time series data displayed in the display device.
